(19) United States
(12) Patent Application Publication
(10) Pub. No.: US 2021/0279892 A1
(43) Pub. Date: Sep. 9, 2021

(54) IMAGE PROCESSING METHOD AND DEVICE, AND NETWORK TRAINING METHOD AND DEVICE

(71) Applicant: BEIJING SENSETIME TECHNOLOGY DEVELOPMENT CO., LTD., Beijing (CN)

(72) Inventors: Xiaohang ZHAN, Beijing (CN); Xingang PAN, Beijing (CN); Ziwei LIU, Beijing (CN); Dahua LIN, Beijing (CN); Chen Change LOY, Beijing (CN)

(21) Appl. No.: 17/329,534

(22) Filed: May 25, 2021

Related U.S. Application Data
(63) Continuation of application No. PCT/CN2019/114769, filed on Oct. 31, 2019.

(30) Foreign Application Priority Data
Jan. 29, 2019 (CN) 201910086044.3

(51) Int. Cl. G06T 7/246; G06N 3/08; G06N 3/04; G06K 9/00; G06K 9/62

(52) U.S. Cl. CPC G06T 7/246; G06N 3/08; G06K 9/629; G06K 9/00342; G06N 3/0454

(57) ABSTRACT

An image processing method and a device, and a network training method and a device are provided. The image processing method includes determining a guide group arranged on an image to be processed and directed at a target object, the guide group comprising at least one guide point, and the guide point being used to indicate the position of a sampling pixel, and the magnitude and direction of the motion speed of the sampling pixel; and on the basis of the guide point in the guide group and the image to be processed, performing optical flow prediction to obtain the motion of the target object in the image to be processed.

### CROSS-REFERENCE TO RELATED APPLICATION

This is a continuation application of International Patent Application No. PCT/CN2019/114769, filed on Oct. 31, 2019, which claims priority to China Patent Application No. 201910086044.3, filed to the Chinese Patent Office on Jan. 29, 2019 and entitled “Image Processing Method and Device, and Network Training Method and Device”. The disclosures of International Patent Application No. PCT/CN2019/114769 and China Patent Application No. 201910086044.3 are hereby incorporated by reference in their entireties.

### BACKGROUND

Along with the development of sciences and technologies, an intelligent system may simulate a person to learn a motion feature of an object from a motion of the object, thereby completing advanced visual tasks such as object detection and segmentation through the learned motion feature.

Such a hypothesis that there is a certain strong association relationship between an object and a motion feature is made, for example, it is hypothesized that motions of pixels of the same object are the same, to further predict a motion of the object. However, most of objects are relatively high in degree of freedom, and motion is usually complicated. Even for the same object, there are also multiple motion patterns, such as translation, rotation, deformation and the like, for different parts. The accuracy that predicting a motion based on the certain strong association relationship hypothesized between the object and the motion feature is relatively low.

### SUMMARY

The disclosure relates to the technical field of image processing, and particularly to an image processing method and device, and a network training method and device.

The disclosure discloses technical solutions of an image processing method and device and network training method and device.

According to an aspect of the disclosure, an image processing method is provided, which may include the following operations.

A guidance group set for a target object in an to-be-processed image is determined, the guidance group including at least one guidance point, the guidance point being configured to indicate a position of a sampling pixel and a magnitude and direction of a motion velocity of the sampling pixel and the sampling pixel being a pixel of the target object in the to-be-processed image.

Optical flow prediction is performed according to the guidance point in the guidance group and the to-be-processed image to obtain a motion of the target object in the to-be-processed image.

According to an aspect of the disclosure, a network training method is provided, which may include the following operations.

A first sample group is acquired, the first sample group including an to-be-processed image sample and a first motion corresponding to a target object in the to-be-processed image sample.

Sampling processing is performed on the first motion to obtain a sparse motion corresponding to the target object in the to-be-processed image sample and a binary mask corresponding to the target object in the to-be-processed image sample.

The optical flow prediction is performed, by inputting the sparse motion corresponding to the target object in the to-be-processed image sample, the binary mask corresponding to the target object in the to-be-processed image sample and the to-be-processed image sample to a first neural network, to obtain a second motion corresponding to the target object in the to-be-processed image sample.

Motion loss of the first neural network is determined according to the first motion and the second motion.

A parameter of the first neural network is regulated according to the motion loss.

According to an aspect of the disclosure, an image processing device is provided, which may include a first determination module and a prediction module.

The first determination module may be configured to determine a guidance group set for a target object in an to-be-processed image, the guidance group including at least one guidance point, the guidance point being configured to indicate a position of a sampling pixel and a magnitude and direction of a motion velocity of the sampling pixel and the sampling pixel being a pixel of the target object in the to-be-processed image.

The prediction module may be configured to perform optical flow prediction according to the guidance point in the guidance group and the to-be-processed image to obtain a motion of the target object in the to-be-processed image.

According to an aspect of the disclosure, a network training device is provided, which may include an acquisition module, a processing module, a prediction module, a determination module and a regulation module.

The acquisition module may be configured to acquire a first sample group, the first sample group including an to-be-processed image sample and a first motion corresponding to a target object in the to-be-processed image sample.

The processing module may be configured to perform sampling processing on the first motion to obtain a sparse motion corresponding to the target object in the to-be-processed image sample and a binary mask corresponding to the target object in the to-be-processed image sample.

The prediction module may be configured to perform, by inputting the sparse motion corresponding to the target object in the to-be-processed image sample, the binary mask corresponding to the target object in the to-be-processed image sample and the to-be-processed image sample to a first neural network, optical flow prediction to obtain a second motion corresponding to the target object in the to-be-processed image sample.

The determination module may be configured to determine a motion loss of the first neural network according to the first motion and the second motion.

The regulation module may be configured to regulate a parameter of the first neural network according to the motion loss.

According to an aspect of the disclosure, an electronic device is provided, which may include a processor and a memory. The memory is configured to store instructions executable for the processor. The processor may be configured to execute the abovementioned methods.

According to an aspect of the disclosure, a computer-readable storage medium is provided, in which computer program instructions may be stored, the computer program instruction being executed by a processor to implement the abovementioned methods.

According to an aspect of the disclosure, a computer program is provided, which may include computer-readable codes, the computer-readable codes running in an electronic device to enable a processor of the electronic device to execute the abovementioned methods.

It is to be understood that the above general description and the following detailed description are only exemplary and explanatory and not intended to limit the disclosure.

According to the following detailed descriptions made to exemplary embodiments with reference to the drawings, other features and aspects of the disclosure may become clear.

### BRIEF DESCRIPTION OF THE DRAWINGS

The accompanying drawings, which are incorporated in and constitute a part of this specification, illustrate embodiments consistent with the disclosure and, together with the specification, serve to describe the technical solutions of the disclosure.

FIG. 1 is a flowchart of an image processing method according to embodiments of the disclosure.

FIG. 2 is an exemplary schematic diagram of guidance point setting for an to-be-processed image according to the disclosure.

FIG. 3 is an exemplary schematic diagram of an optical flow according to the disclosure.

FIG. 4 is an exemplary schematic diagram of a sparse motion and a binary mask according to the disclosure.

FIG. 5 is a flowchart of an image processing method according to embodiments of the disclosure.

FIG. 6 is a schematic diagram of a first neural network according to embodiments of the disclosure.

FIG. 7 is a flowchart of an image processing method according to an embodiment of the disclosure.

FIG. 8 is an exemplary schematic diagram of a video generation process according to the disclosure.

FIG. 9 is a flowchart of an image processing method according to embodiments of the disclosure.

FIG. 10 is an exemplary schematic diagram of a mask generation process according to the disclosure.

FIG. 11 is a flowchart of a network training method according to embodiments of the disclosure.

FIG. 12 is a structure block diagram of an image processing device according to embodiments of the disclosure.

FIG. 13 is a structure block diagram of a network training device according to embodiments of the disclosure.

FIG. 14 is a block diagram of an electronic device 800 according to exemplary embodiments.

FIG. 15 is a block diagram of an electronic device 1900 according to exemplary embodiments.

### DETAILED DESCRIPTION

In the embodiments of the disclosure, after the guidance group, including the at least one guidance point, set for the target object in the to-be-processed image is acquired, optical flow prediction may be performed according to the guidance point in the guidance group and the to-be-processed image to obtain the motion of the target object in the to-be-processed image. According to the image processing method and device provided in the embodiments of the disclosure, the motion of the target object may be predicted based on the guidance of the guidance point independently of a hypothesis about a strong association between the target object and the motion thereof, so that the quality of predicting the motion of the target object may be improved.

Each exemplary embodiment, feature and aspect of the disclosure will be described below with reference to the drawings in detail. The same reference signs in the drawings represent components with the same or similar functions. Although each aspect of the embodiments is shown in the drawings, the drawings are not required to be drawn to scale, unless otherwise specified.

Herein, special term “exemplary” refers to “use as an example, embodiment or description”. Herein, any “exemplarily” described embodiment may not be explained to be superior to or better than other embodiments.

In the disclosure, term “and/or” is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple or any combination of at least two of multiple. For example, including at least one of A, B and C may represent including any one or more elements selected from a set formed by A, B and C.

In addition, for describing the disclosure better, many specific details are presented in the following specific implementation modes. It is understood by those skilled in the art that the disclosure may still be implemented even without some specific details. In some examples, methods, means, components and circuits known very well to those skilled in the art are not described in detail, to highlight the subject of the disclosure.

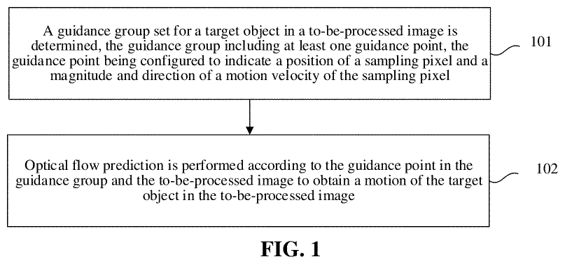

FIG. 1 is a flowchart of an image processing method according to an embodiment of the disclosure. The image processing method may be executed by a terminal device or another processing device. The terminal device may be User Equipment (UE), a mobile device, a user terminal, a terminal, a cell phone, a cordless phone, a Personal Digital Assistant (PDA), a handheld device, a computing device, a vehicle device, a wearable device and the like. The other processing device may be a server or a cloud server, etc. In some possible implementation modes, the image processing method may be implemented in a manner that a processor calls computer-readable instructions stored in a memory.

As shown in FIG. 1, the method may include the following operations.

In 101, a guidance group set for a target object in an to-be-processed image is determined, the guidance group including at least one guidance point, the guidance point being configured to indicate a position of a sampling pixel and a magnitude and direction of a motion velocity of the sampling pixel.

For example, at least one guidance point may be set for the target object in the to-be-processed image, and the at least one guidance point may form a guidance group. Any one guidance point may correspond to a sampling pixel, and the guidance point may include a position of the sampling pixel corresponding to the guidance point and a magnitude and direction of a motion velocity of the sampling pixel.

Exemplarily, multiple sampling pixels of the target object in the to-be-processed image may be determined, and guidance points (including magnitudes and directions of motion velocities of the sampling pixels) may be set at the multiple sampling pixels.

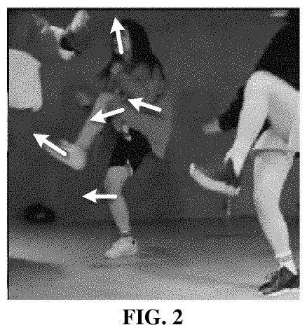

FIG. 2 is an exemplary schematic diagram of guidance point setting for an to-be-processed image according the disclosure.

For example, referring to the to-be-processed image shown in FIG. 2, a target object in the to-be-processed image is a person, namely a motion of the person is required to be predicted in the example. In such case, a guidance point may be set at a key position of the person, such as the body, the head and the like. The guidance point may be represented in form of an arrowhead, a length of the arrowhead mapping a magnitude of a motion velocity of a sampling pixel indicated by the guidance point (called the magnitude of the motion velocity indicated by the guidance point hereinafter for short) and a direction of the arrowhead mapping a direction of the motion velocity of the sampling pixel indicated by the guidance point (called the direction of the motion velocity indicated by the guidance point hereinafter for short). A user may set the direction of the arrowhead to set the direction of the motion velocity indicated by the guidance point and may set the length of the arrowhead to set the magnitude of the motion velocity indicated by the guidance point (or, may input the magnitude of the motion velocity indicated by the guidance point through an input box). Or, after a position of the guidance point is selected, the direction of the motion velocity indicated by the guidance point (the direction of the motion velocity indicated by the guidance point may be represented through an angle (0˜360°)) and the magnitude of the motion velocity indicated by the guidance point may be input through the input box. A setting manner for the guidance point is not specifically limited in the disclosure.

In 102, optical flow prediction is performed according to the guidance point in the guidance group and the to-be-processed image to obtain a motion of the target object in the to-be-processed image.

In a possible implementation mode, the operation in 102 that optical flow prediction is performed according to the guidance point in the guidance group and the to-be-processed image to obtain the motion of the target object in the to-be-processed image may include the following operation.

Optical flow prediction is performed by inputting the guidance point in the guidance group and the to-be-processed image are input to a first neural network, to obtain the motion of the target object in the to-be-processed image.

For example, the first neural network may be a network obtained by training through a large number of training samples and configured to perform optical flow prediction by performing full-extent propagation on the magnitude and direction of the motion velocity indicated by the guidance point. After the guidance point is acquired, the optical flow prediction may be performed by inputting the guidance point (the position and the magnitude and direction of the motion velocity) set for the target object in the guidance group and the to-be-processed image to the first neural network, thereby guiding a motion of a pixel corresponding to the target object in the to-be-processed image through the set guidance point to obtain the motion of the target object in the to-be-processed image. The first neural network may be a conditioned motion propagation network.

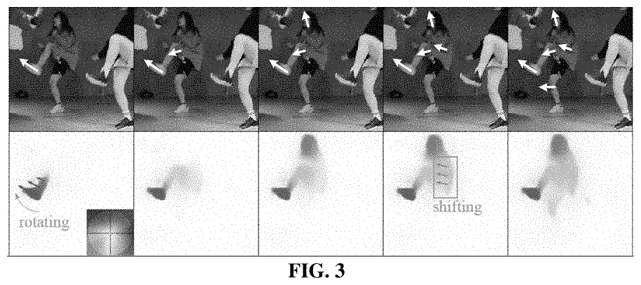

FIG. 3 is an exemplary schematic diagram of an optical flow according to the disclosure.

Exemplarily, as shown in images of the first row in FIG. 3, sequentially, a guidance point is set for the left foot of the person in the to-be-processed image, a guidance point is set for each of the left foot and left leg of the person in the to-be-processed image, a guidance point is set for each of the left foot, left leg and head of the person in the to-be-processed image, a guidance point is set for each of the left foot, left leg, head and body of the person in the to-be-processed image, and a guidance point is set for each of the left foot, left leg, head, body and right leg of the person in the to-be-processed image. After the guidance points set by the above five guidance point setting manners are input to the first neural network, a motion corresponding to the left foot of the person is generated, motions corresponding to the left foot and left leg of the person are generated, motions corresponding to the left foot, left leg and head of the person are generated, motions corresponding to the left foot, left leg, head and body of the person are generated, and motions corresponding to the left foot, left leg, head, body and right leg of the person are generated. Optical flow images corresponding to the motions generated by the above five guidance point setting manners are as shown in images of the second row in FIG. 3. The first neural network may be the conditioned motion propagation network.

Accordingly, after the guidance group, including the at least one guidance point, set for the target object in the to-be-processed image is acquired, optical flow prediction may be performed according to the guidance point in the guidance group and the to-be-processed image to obtain the motion of the target object in the to-be-processed image. According to the image processing method provided in the embodiments of the disclosure, the motion of the target object may be predicted based on the guidance of the guidance point independently of a hypothesis about a strong association between the target object and the motion thereof, so that the quality of predicting the motion of the target object may be improved.

In a possible implementation mode, the operation in 102 that optical flow prediction is performed according to the guidance point in the guidance group and the to-be-processed image to obtain the motion of the target object in the to-be-processed image may include the following operation.

Optical flow prediction is performed according to the magnitude and direction of the motion velocity of the sampling pixel indicated by the guidance point in the guidance group, the position of the sampling pixel indicated by the guidance point in the guidance group and the to-be-processed image to obtain the motion of the target object in the to-be-processed image.

For example, the guidance point in the guidance group and the to-be-processed image may be input to the first neural network, and the first neural network performs full-extent propagation on the magnitude and direction of the motion velocity indicated by the guidance point and the position of the sampling pixel indicated by the guidance point in the guidance group in the to-be-processed image to guide the motion of the target object in the to-be-processed image according to the guidance point, thereby obtaining the motion of the target object in the to-be-processed image.

In a possible implementation mode, the operation in 102 that optical flow prediction is performed according to the guidance point in the guidance group and the to-be-processed image to obtain the motion of the target object in the to-be-processed image may include the following operations.

A sparse motion corresponding to the target object in the to-be-processed image is generated according to the magnitude and direction of the motion velocity of the sampling pixel indicated by the guidance point in the guidance group, the sparse motion being configured to indicate a magnitude and direction of a motion velocity of each sampling pixel of the target object.

A binary mask corresponding to the target object in the to-be-processed image is generated according to the position of the sampling pixel indicated by the guidance point in the guidance group.

Optical flow prediction is performed according to the sparse motion, the binary mask and the to-be-processed image to obtain the motion of the target object in the to-be-processed image.

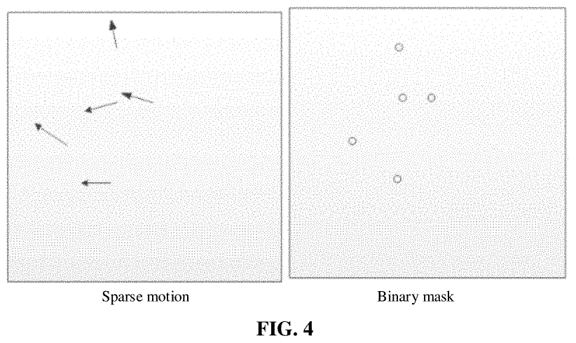

FIG. 4 is an exemplary schematic diagram of a sparse motion and a binary mask according to the disclosure.

For example, the sparse motion corresponding to the target object in the to-be-processed image may be generated according to magnitudes and directions of motion velocities indicated by all guidance points in the guidance group, and the sparse motion is configured to indicate the magnitude and direction of the motion velocity of each sampling pixel of the target object (for the to-be-processed image shown in FIG. 2, the sparse motion corresponding to the guidance points may refer to FIG. 4). The binary mask corresponding to the target object in the to-be-processed image may be generated according to positions indicated by all the guidance points in the guidance group, and the binary mask may be configured to indicate the position of each sampling pixel of the target object (for the to-be-processed image shown in FIG. 2, the binary mask corresponding to the guidance points may refer to FIG. 4).

For example, the sparse motion, the binary mask and the to-be-processed image may be input to the first neural network to perform optical flow prediction, thereby obtaining the motion of the target object in the to-be-processed image. The first neural network may be the conditioned motion propagation network.

According to the image processing method provided in the embodiments of the disclosure, the motion of the target object may be predicted based on the guidance of the guidance point independently of the hypothesis about the strong association between the target object and the motion thereof, so that the quality of predicting the motion of the target object may be improved.

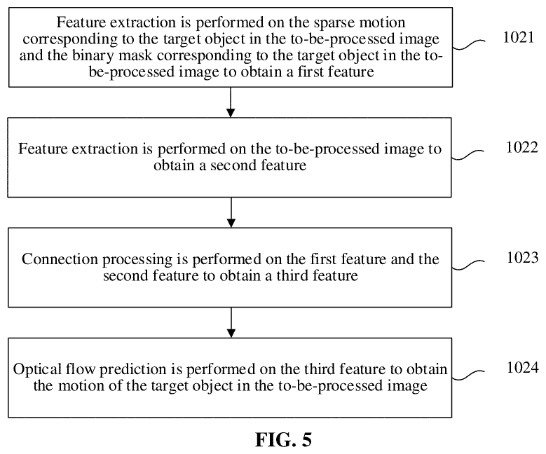

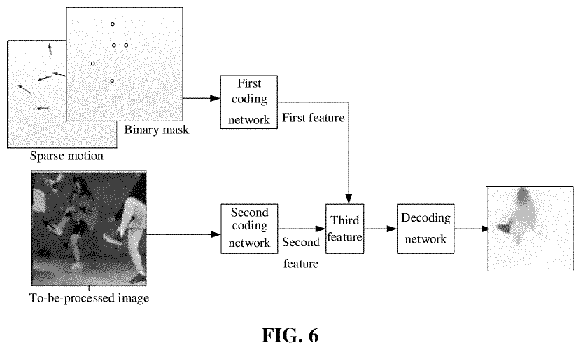

FIG. 5 is a flowchart of an image processing method according to an embodiment of the disclosure. FIG. 6 is a schematic diagram of a first neural network according to an embodiment of the disclosure.

In a possible implementation mode, the first neural network may include a first coding network, a second coding network and a decoding network (as shown in FIG. 6). Referring to FIG. 5 and FIG. 6, the operation that optical flow prediction is performed according to the sparse motion, the binary mask and the to-be-processed image to obtain the motion of the target object in the to-be-processed image may include the following operations.

In 1021, feature extraction is performed on the sparse motion corresponding to the target object in the to-be-processed image and the binary mask corresponding to the target object in the to-be-processed image to obtain a first feature.

For example, the sparse motion corresponding to the target object in the to-be-processed image and the binary mask corresponding to the target object in the to-be-processed image may be input to the first coding network to perform feature extraction, thereby obtaining the first feature. The first coding network may be a neural network configured to code the sparse motion and binary mask of the target object to obtain a compact sparse motion feature, and the compact sparse motion feature is the first feature. For example, the first coding network may be a neural network formed by two Convolution-Batch Normalization-Rectified Linear Unit-Pooling (Conv-BN-ReLU-Pooling) blocks.

In 1022, feature extraction is performed on the to-be-processed image to obtain a second feature.

For example, feature extraction is performed by inputting the to-be-processed image to the second coding network to obtain the second feature. The second coding network may be configured to code the to-be-processed image to extract a kinematic attribute of the target object from the static to-be-processed image (for example, features that such as the crus of the person is a rigid body structure, motions as a whole and the like, are extracted) to obtain a deep feature, and the deep feature is the second feature. The second coding network is a neural network, which may be, for example, a neural network formed by an AlexNet/ResNet-50 and a convolutional layer.

In 1023, connection processing is performed on the first feature and the second feature to obtain a third feature.

For example, both the first feature and the second feature are tensors. Connection processing may be performed on the first feature and the second feature to obtain the third feature. The third feature is also a tensor.

Exemplarily, if a dimension of the first feature is c1×h×w and a dimension of the second feature is c2×h×w, a dimension of the third feature obtained by connection processing may be (c1+c2)×h×w.

In 1024, optical flow prediction is performed on the third feature to obtain the motion of the target object in the to-be-processed image.

For example, optical flow prediction may be performed by inputting the third feature to the decoding network to obtain the motion of the target object in the to-be-processed image. The decoding network is configured to perform optical flow prediction according to the third feature, and an output of the decoding network is the motion of the target object in the to-be-processed image.

In a possible implementation mode, the decoding network may include at least two propagation networks and a fusion network, and the operation that optical flow prediction is performed on the third feature to obtain the motion of the target object in the to-be-processed image may include the following operations.

Full-extent propagation processing is performed by inputting the third feature to the at least two propagation networks respectively to obtain a propagation result corresponding to each propagation network.

Fusion performing is performed by inputting the propagation result corresponding to each propagation network to a fusion network to obtain the motion of the target object in the to-be-processed image.

For example, the decoding network may include the at least two propagation networks and a fusion network. Each propagation network may include a max pooling layer and two stacked Conv-BN-ReLU blocks. The fusion network may include a single convolutional layer. The above third feature may be input to each propagation network respectively, and each propagation network propagates the third feature to a full extent of the to-be-processed image to recover a full-extent motion of the to-be-processed image through the third feature to obtain the propagation result corresponding to each propagation network.

Exemplarily, the decoding network may include three propagation networks, and the three propagation networks are formed by convolutional neural networks with different spatial steps. For example, convolutional neural networks with spatial steps 1, 2 and 4 respectively may form three propagation networks, the propagation network 1 may be formed by the convolutional neural network with the spatial step 1, the propagation network 2 may be formed by the convolutional neural network with the spatial step 2, and the propagation network 3 may be formed by the convolutional neural network with the spatial step 4.

The fusion network may perform fusion processing on the propagation result of each propagation network to obtain the corresponding motion of the target object. The first neural network may be the conditioned motion propagation network.

According to the image processing method provided in the embodiments of the disclosure, the motion of the target object may be predicted based on the guidance of the guidance point independently of the hypothesis about the strong association between the target object and the motion thereof, so that the quality of predicting the motion of the target object may be improved.

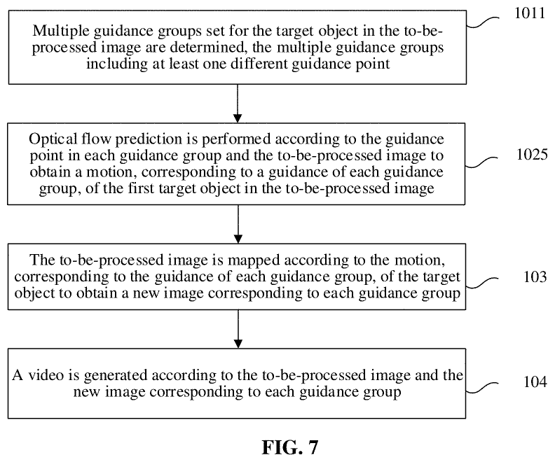

FIG. 7 is a flowchart of an image processing method according to an embodiment of the disclosure.

In a possible implementation mode, referring to FIG. 7, the operation in 101 that the guidance group set for the target object in the to-be-processed image is determined may include the following operation.

In 1011, multiple guidance groups set for the target object in the to-be-processed image are determined, each of the multiple guidance groups including at least one guidance point different from guidance points of other guidance groups.

For example, the user may set multiple guidance groups for the target object, each guidance group may include at least one guidance point, and different guidance groups include at least one guidance point different from guidance points of other guidance groups.

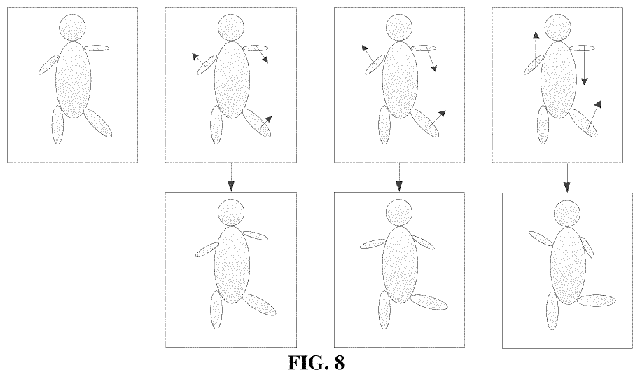

FIG. 8 is an exemplary schematic diagram of a video generation process according to the disclosure.

Exemplarily, referring to FIG. 8, the user sequentially sets three guidance groups for the target object in the to-be-processed image. The guidance group 1 includes a guidance point 1, a guidance point 2 and a guidance point 3. The guidance group 2 includes a guidance point 4, a guidance point 5 and a guidance point 6. The guidance group 3 includes a guidance point 7, a guidance point 8 and a guidance point 9.

It is to be noted that the guidance points set in different guidance groups may be set at the same position (for example, in FIG. 8, the guidance point 1 in the guidance group 1, the guidance point 4 in the guidance group 2 and the guidance point 7 in the guidance group 3 are set at the same position but indicate different magnitudes and directions of motion velocities respectively) and may also be set at different positions, or different guidance groups may also include guidance points set at the same position and indicating the same magnitude and direction of the motion velocities. No limits are made thereto in the embodiments of the disclosure.

In a possible implementation mode, referring to FIG. 7, the operation in 102 that optical flow prediction is performed according to the guidance point in the guidance group and the to-be-processed image to obtain the motion of the target object in the to-be-processed image may include the following operation.

In 1025, optical flow prediction is performed according to a guidance point in each guidance group and the to-be-processed image to obtain a motion, corresponding to a guidance of each guidance group, of the target object in the to-be-processed image.

For example, optical flow prediction may be performed by sequentially inputting the guidance point in each guidance group and the to-be-processed image to the first neural network to obtain the motion, corresponding to the guidance of each guidance group, of the target object in the to-be-processed image.

Exemplarily, optical flow prediction may be performed by inputting the guidance group 1 and the to-be-processed image to the first neural network, to obtain a motion 1, corresponding to a guidance of the guidance group 1, of the target object in the to-be-processed image. The optical flow prediction is performed by inputting the guidance group 2 and the to-be-processed image to the first neural network to obtain a motion 2, corresponding to a guidance of the guidance group 2, of the target object in the to-be-processed image. The optical flow prediction is performed by inputting the guidance group 3 and the to-be-processed image to the first neural network, to obtain a motion 3, corresponding to a guidance of the guidance group 3, of the target object in the to-be-processed image. The first neural network may be the conditioned motion propagation network.

In a possible implementation mode, referring to FIG. 7, the method further includes the following operations.

In 103, the to-be-processed image is mapped according to the motion, corresponding to the guidance of each guidance group, of the target object to obtain a new image corresponding to each guidance group.

In 104, a video is generated according to the to-be-processed image and the new image corresponding to each guidance group.

For example, each pixel in the to-be-processed image may be mapped according to the motion (the magnitude and direction of the motion velocity) corresponding to the pixel to obtain a corresponding new image.

Exemplarily, a position of a certain pixel in the to-be-processed image is (X, Y) and the corresponding motion information of the pixel in the motion 1 includes that the direction of the motion velocity is 110 degrees and the magnitude of the motion velocity is (x1, y1). After mapping, the pixel motions at the motion velocity of which the magnitude is (x1, y1) in the 110-degree direction, and a position of the pixel in the to-be-processed image after motion is (X1, Y1). After each pixel in the to-be-processed image is mapped according to the motion 1, a new image 1 may be obtained. By such analogy, after each pixel in the to-be-processed image is mapped according to the motion 2, a new image 2 may be obtained, and after each pixel in the to-be-processed image is mapped according to the motion 3, a new image 3 may be obtained, referring to FIG. 8.

After the corresponding new images are obtained according to each guidance group, the to-be-processed image and the new image corresponding to each guidance group may form an image sequence, and the corresponding video may be generated according to the image sequence. For example, a video of which the content is that the person waves the arms and the legs may be correspondingly generated according to the to-be-processed image, new image 1, new image 2 and new image 3 in FIG. 8.

Therefore, the user may set the guidance point(s) to specify the motion direction and motion velocity of the target object through the guidance point(s) and further generate the corresponding video. The generated video meet an expectation of the user better and is higher in quality, and a video generation manner is enriched.

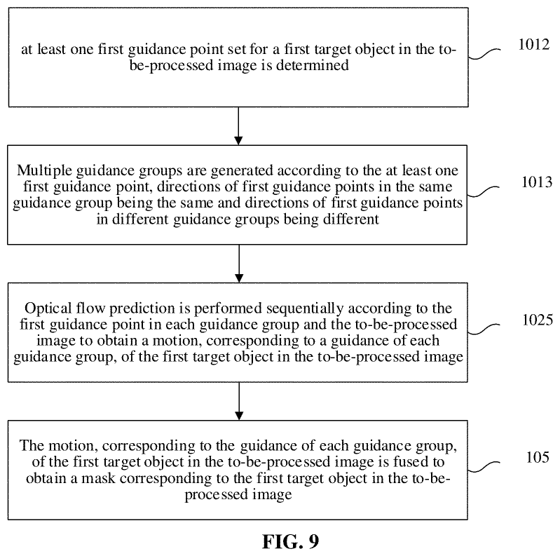

FIG. 9 is a flowchart of an image processing method according to an embodiment of the disclosure.

In a possible implementation mode, referring to FIG. 9, the operation in 101 that the guidance group set for the target object in the to-be-processed image is determined may include the following operations.

In 1012, at least one first guidance point set for a first target object in the to-be-processed image is determined.

For example, the user may determine a position of the at least one first guidance point for the first target object in the to-be-processed image and set the first guidance point at the corresponding position.

In 1013, multiple guidance groups are generated according to the at least one first guidance point, directions of first guidance points in the same guidance group being the same and directions of first guidance points in different guidance groups being different.

After the first guidance point(s) is acquired, multiple directions may be set for each first guidance point to generate multiple guidance groups. For example, it is set that a direction of a first guidance point in the guidance group 1 is upward, a direction of the first guidance point in the guidance group 2 is downward, a direction of the first guidance point in the guidance group 3 is leftward, and a direction of the first guidance point in the guidance group 4 is rightward. A motion velocity of the first guidance point is not 0. The direction of the guidance point can be understood as the direction of the motion velocity of the sampling pixel indicated by the guidance point.

In a possible implementation mode, referring to FIG. 9, the operation in 102 that optical flow prediction is performed according to the acquired guidance point in the guidance group and the to-be-processed image to obtain the motion of the target object in the to-be-processed image may include the following operation.

In 1025, optical flow prediction is performed according to the first guidance point(s) in each guidance group and the to-be-processed image to obtain a motion, corresponding to a guidance of each guidance group, of the first target object in the to-be-processed image.

After the guidance group corresponding to each direction is obtained, optical flow prediction may be performed on the target object according to each guidance group to obtain a motion of the target object in each direction.

Exemplarily, optical flow prediction may be performed by inputting the first guidance point(s) in any one guidance group and the to-be-processed image to the first neural network, to obtain the motion of the target object in the direction corresponding to the guidance group.

In a possible implementation mode, referring to FIG. 9, the method may further include the following operation.

In 105, the motion, corresponding to the guidance of each guidance group, of the first target object in the to-be-processed image is fused to obtain a mask corresponding to the first target object in the to-be-processed image.

After the corresponding motion of the first target object in each direction is obtained, the motion in each direction may be fused (for example, manners of calculating an average value, calculating an intersection or calculating a union may be adopted, and a fusion manner is not specifically limited in the embodiments of the disclosure), to obtain the mask corresponding to the first target object in the to-be-processed image.

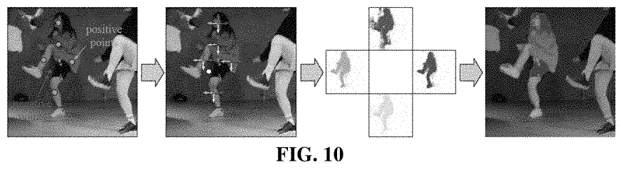

FIG. 10 is an exemplary schematic diagram of a mask generation process according to the disclosure.

Exemplarily, as shown in FIG. 10, the user sets first guidance points (five first guidance points are set) for a person 1 in the to-be-processed image. For the five first guidance points set by the user, four guidance groups are generated in upward, downward, leftward and rightward directions respectively. Optical flow prediction is performed on the person 1 according to the first neural network and the four guidance groups to obtain motions of the target object in the upward, downward, leftward and rightward directions: the motion 1, the motion 2, the motion 3 and a motion 4. The motion 1, motion 2, motion 3 and motion 4 corresponding to the four guidance groups are fused to obtain a mask of the person 1. The first neural network may be the conditioned motion propagation network.

In some possible implementation modes, the method may further include the following operation.

At least one second guidance point set in the to-be-processed image is determined, a motion velocity of the second guidance point being 0.

For example, a second target object may be an object occluding the first target object or close to the first target object. When the first guidance point for the first target object is set, the second guidance point for the second target object may be set at the same time.

Exemplarily, the first guidance point may be set through a first guidance point setting tool, and the second guidance point may be set through a second guidance point setting tool. Or, when a guidance point is set, an option corresponding to the first guidance point or the second guidance point may be selected to determine that the guidance point is the first guidance point or the second guidance point. On a display interface, the color of the first guidance point is different from that of the second guidance point (for example, the first guidance point is green and the second guidance point is red), or the shape of the first guidance point is different from that of the second guidance point (the first guidance point is a circle and the second guidance point is a cross).

In the embodiments of the disclosure, the operation that optical flow prediction is performed according to the first guidance point in each guidance group and the to-be-processed image to obtain the motion, corresponding to the guidance of each guidance group, of the first target object in the to-be-processed image may include the following operation.

Optical flow prediction is performed sequentially according to the first guidance point in each guidance group, the second guidance point and the to-be-processed image to obtain the motion, corresponding to the guidance of each guidance group, of the first target object in the to-be-processed image.

Since the first guidance point has a motion velocity and the motion velocity of the second guidance point is 0, an optical flow may be generated nearby the first guidance point, and no optical flow is generated nearby the second guidance point. In such a manner, no mask may be generated at an occluded part in the mask of the first target object or an adjacent part of the first target object, so that the quality of the generated mask may be improved.

Therefore, the user only needs to set the position of the first guidance point for the first target object in the to-be-processed image (or, as well as the second guidance point) to generate the mask of the first target object. Higher robustness is achieved, and user operations are simplified, namely the mask generation efficiency and quality are improved.

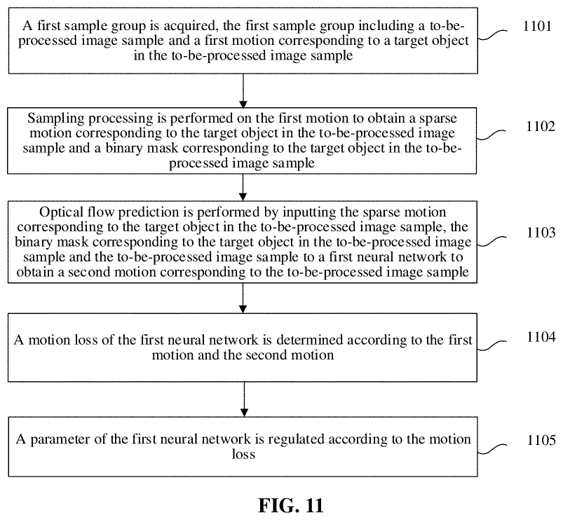

FIG. 11 is a flowchart of a network training method according to an embodiment of the disclosure. The network training method may be executed by a terminal device or another processing device. The terminal device may be UE, a mobile device, a user terminal, a terminal, a cell phone, a cordless phone, a PDA, a handheld device, a computing device, a vehicle device, a wearable device and the like. The other processing device may be a server or a cloud server, etc. In some possible implementation modes, the image processing method may be implemented in a manner that a processor calls computer-readable instructions stored in a memory.

As shown in FIG. 11, the method may include the following operations.

In 1101, a first sample group is acquired, the first sample group including an to-be-processed image sample and a first motion corresponding to a target object in the to-be-processed image sample.

In 1102, sampling processing is performed on the first motion to obtain a sparse motion corresponding to the target object in the to-be-processed image sample and a binary mask corresponding to the target object in the to-be-processed image sample.

In 1103, optical flow prediction is performed by inputting the sparse motion corresponding to the target object in the to-be-processed image sample, the binary mask corresponding to the target object in the to-be-processed image sample and the to-be-processed image sample to a first neural network to obtain a second motion corresponding to the to-be-processed image sample.

In 1104, a motion loss of the first neural network is determined according to the first motion and the second motion.

In 1105, a parameter of the first neural network is regulated according to the motion loss.

For example, a first sample group may be set. For example, an image combination of which an interval is less than a frame value threshold (for example, 10 frames) is acquired from a video to calculate optical flow. If video segments 1, 4, 10, 21 and 28 including five video frames are acquired from a video, video frame combinations of which intervals are less than 10 frames including [1, 4], [4, 10] and [21, 28], a corresponding optical flow may be calculated according to images of the two video frames in each video frame combination. The image of the frame with a relatively small frame number in the video frame combination is determined as an to-be-processed image sample, and the optical flow corresponding to the video frame combination is determined as a first motion corresponding to the to-be-processed image sample.

In a possible implementation mode, the operation that sampling processing is performed on the first motion to obtain the sparse motion corresponding to the target object in the to-be-processed image sample and the binary mask corresponding to the target object in the to-be-processed image sample may include the following operations.

Edge extraction processing is performed on the first motion to obtain an edge graph corresponding to the first motion.

At least one key point in the edge graph is determined.

The binary mask corresponding to the target object in the to-be-processed image sample is obtained according to a position of the at least one key point, and the sparse motion corresponding to the target object in the to-be-processed image sample is obtained according to a motion corresponding to the at least one key point, the motion corresponding to the key point being a motion, of a pixel corresponding to the key point, in the first motion, and the pixel corresponding to the key point being a pixel corresponding to the key point in the edge graph.

For example, edge extraction processing may be performed on the first motion. For example, edge extraction processing is performed on the first motion through a watershed algorithm to obtain the edge graph corresponding to the first motion. Then, at least one key point in an internal region of an edge in the edge graph may be determined. All such key points may fall in the target object. For example, the at least one key point in the edge graph may be determined by use of a non-maximum suppression algorithm of which a kernel size is K, and if K is greater, the number of corresponding key points is smaller.

Positions of all the key points in the to-be-processed image sample form the binary mask of the target object. Motions, of pixels corresponding to all the key points, in the first motion form the sparse motion corresponding to the target object in the to-be-processed image sample.

The second motion corresponding to the target object in the to-be-processed image sample may be obtained by inputting the binary mask corresponding to the to-be-processed image sample and the sparse motion corresponding to the to-be-processed image sample to the first neural network to perform optical flow prediction. Motion loss between the first motion and the second motion is determined through a loss function (for example, a cross entropy loss function). When the motion loss between the first motion and the second motion meets a training accuracy requirement (for example, less than a preset loss threshold), it is determined that training for the first neural network is completed and the training operation is stopped, otherwise the parameter in the first neural network is regulated and the first neural network is continued to be trained according to the first sample group.

In a possible implementation mode, the first neural network may be a conditioned motion propagation network.

For example, the first neural network may include a first coding network, a second coding network and a decoding network. Structures of the first coding network, the second coding network and the decoding network may refer to the abovementioned embodiments and will not be elaborated in the embodiments of the disclosure.

Exemplarily, the first neural network may be pertinently trained as required. For example, when a first neural network applied to face recognition is trained, the to-be-processed image sample in the first sample group may be a face image of a person. When a first neural network applied to human limbs recognition is trained, the to-be-processed image sample in the first sample group may be an image of a body of the person.

In such a manner, according to the embodiments of the disclosure, unsupervised training may be performed on the first neural network through a large number of untagged image samples, and the first neural network obtained by training may predict a motion of the target object according to a guidance of a guidance point independently of a hypothesis about a strong association between the target object and the motion thereof, so that the quality of predicting the motion of the target object may be improved. Moreover, the first coding network in the first neural network may be as an used as an image coder to be used for a large number of advanced visual tasks (for example, target detection, semantic segmentation, instance segmentation and human parsing). Parameter(s) of the image coder in the network corresponding to the advanced visual tasks may be initialized according to parameter(s) of the second coding network in the first neural network. The network corresponding to the advanced visual tasks may be endowed with relatively high performance during initialization, and the performance of the network corresponding to the advanced visual tasks may be greatly improved.

It can be understood that each method embodiment mentioned in the disclosure may be combined to form combined embodiments without departing from principles and logics. For saving the space, elaborations are omitted in the disclosure.

In addition, the disclosure also provides an image processing device, an electronic device, a computer-readable storage medium and a program. All of them may be configured to implement any image processing method provided in the disclosure. Corresponding technical solutions and descriptions refer to the corresponding records in the method part and will not be elaborated.

51 It can be understood by those skilled in the art that, in the method of the specific implementation modes, the writing sequence of each step does not mean a strict execution sequence and is not intended to form any limit to the implementation process and a specific execution sequence of each operation should be determined by functions and probable internal logic thereof.

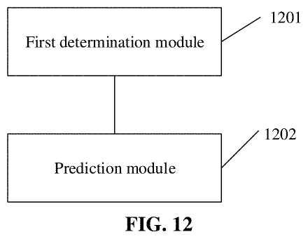

FIG. 12 is a structure block diagram of an image processing device according to an embodiment of the disclosure. As shown in FIG. 12, the device may include a first determination module 1201 and a prediction module 1202.

The first determination module 1201 may be configured to determine a guidance group set for a target object in an to-be-processed image, the guidance group including at least one guidance point, the guidance point being configured to indicate a position of a sampling pixel and a magnitude and direction of a motion velocity of the sampling pixel and the sampling pixel being a pixel of the target object in the to-be-processed image.

The prediction module 1202 may be configured to perform optical flow prediction according to the guidance point in the guidance group and the to-be-processed image to obtain a motion of the target object in the to-be-processed image.

Accordingly, after the guidance group, including the at least one guidance point, set for the target object in the to-be-processed image is acquired, optical flow prediction may be performed according to the guidance point in the guidance group and the to-be-processed image to obtain the motion of the target object in the to-be-processed image. According to the image processing device provided in the embodiments of the disclosure, the motion of the target object may be predicted based on the guidance of the guidance point independently of a hypothesis about a strong association between the target object and the motion thereof, so that the quality of predicting the motion of the target object may be improved.

In a possible implementation mode, the prediction module may further be configured to perform optical flow prediction according to the magnitude and direction of the motion velocity of the sampling pixel indicated by the guidance point in the guidance group, the position of the sampling pixel indicated by the guidance point in the guidance group and the to-be-processed image to obtain the motion of the target object in the to-be-processed image.

In a possible implementation mode, the prediction module may further be configured to generate a sparse motion corresponding to the target object in the to-be-processed image according to the magnitude and direction of the motion velocity of the sampling pixel indicated by the guidance point in the guidance group, the sparse motion being configured to indicate a magnitude and direction of a motion velocity of each sampling pixel of the target object, generate a binary mask corresponding to the target object in the to-be-processed image according to the position of the sampling pixel indicated by the guidance point in the guidance group, the binary mask being configured to indicate a position of each sampling pixel of the target object, and perform optical flow prediction according to the sparse motion, the binary mask and the to-be-processed image to obtain the motion of the target object in the to-be-processed image.

In a possible implementation mode, the prediction module may further be configured to perform optical flow prediction by inputting the guidance point in the guidance group and the to-be-processed image to a first neural network to obtain the motion of the target object in the to-be-processed image.

In a possible implementation mode, the prediction module may further include a sparse motion coding module, an image coding module, a connection module and a sparse motion decoding module.

The sparse motion coding module is configured to perform feature extraction on the sparse motion corresponding to the target object in the to-be-processed image and the binary mask corresponding to the target object in the to-be-processed image to obtain a first feature.

The image coding module is configured to perform feature extraction on the to-be-processed image to obtain a second feature.

The connection module is configured to perform connection processing on the first feature and the second feature to obtain a third feature.

The sparse motion decoding module is configured to perform optical flow prediction on the third feature to obtain the motion of the target object in the to-be-processed image.

In a possible implementation mode, the sparse motion decoding module may further be configured to perform full-extent propagation processing by inputting the third feature to the at least two propagation networks to obtain propagation results respectively corresponding to the propagation networks, and perform fusion processing by inputting the propagation results respectively corresponding to the propagation networks to a fusion network to obtain the motion of the target object in the to-be-processed image.

In a possible implementation mode, the first determination module may further be configured to determine multiple guidance groups set for the target object in the to-be-processed image, the multiple guidance groups including at least one different guidance point.

In a possible implementation mode, the prediction module may further be configured to perform optical flow prediction according to guidance points in the guidance groups and the to-be-processed image to obtain motions, respectively corresponding to guidance of the guidance groups, of the target object in the to-be-processed image.

In a possible implementation mode, the device may further include a mapping module and a video generation module.

The mapping module is configured to map the to-be-processed image according to the motions, respectively corresponding to the guidance of the guidance groups, of the target object to obtain new images respectively corresponding to the guidance groups.

The video generation module is configured to generate a video according to the to-be-processed image and the new images respectively corresponding to the guidance groups.

In a possible implementation mode, the first determination module may further be configured to determine at least one first guidance point set for a first target object in the to-be-processed image, and generate multiple guidance groups according to the at least one first guidance point, directions of first guidance points in the same guidance group being the same and directions of first guidance points in different guidance groups being different.

In a possible implementation mode, the prediction module may further be configured to perform optical flow prediction according to the first guidance points in the guidance groups and the to-be-processed image to obtain motions, respectively corresponding to guidance of the guidance groups, of the first target object in the to-be-processed image.

In a possible implementation mode, the device may further include a fusion module.

The fusion module is configured to fuse the motions, respectively corresponding to the guidance of the guidance groups, of the first target object in the to-be-processed image to obtain a mask corresponding to the first target object in the to-be-processed image.

In a possible implementation mode, the device may further include a second determination module.

The second determination module may be configured to determine at least one second guidance point set in the to-be-processed image, a motion velocity of the second guidance point being 0.

The prediction module may further be configured to perform optical flow prediction according to the first guidance points in the guidance groups, the second guidance point and the to-be-processed image to obtain the motions, respectively corresponding to the guidance of the guidance groups, of the first target object in the to-be-processed image.

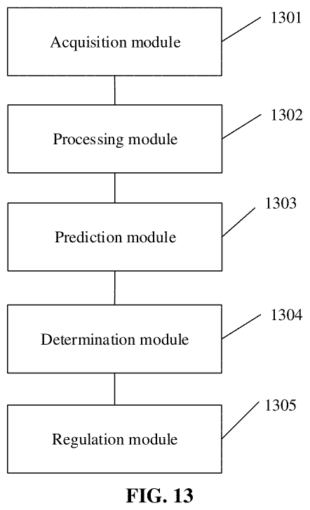

FIG. 13 is a structure block diagram of a network training device according to embodiments of the disclosure. As shown in FIG. 13, the device may include an acquisition module 1301, a processing module 1302, a prediction module 1303, a determination module 1304 and a regulation module 1305.

The acquisition module 1301 may be configured to acquire a first sample group, the first sample group including an to-be-processed image sample and a first motion corresponding to a target object in the to-be-processed image sample.

The processing module 1302 may be configured to perform sampling processing on the first motion to obtain a sparse motion corresponding to the target object in the to-be-processed image sample and a binary mask corresponding to the target object in the to-be-processed image sample.

The prediction module 1303 may be configured to perform optical flow prediction by inputting the sparse motion corresponding to the target object in the to-be-processed image sample and the binary mask corresponding to the target object in the to-be-processed image sample and the to-be-processed image sample to a first neural network to obtain a second motion corresponding to the target object in the to-be-processed image sample.

The determination module 1304 may be configured to determine a motion loss of the first neural network according to the first motion and the second motion.

The regulation module 1305 may be configured to regulate a parameter of the first neural network according to the motion loss.

In a possible implementation mode, the first neural network may be a conditioned motion propagation network.

In a possible implementation mode, the processing module may further be configured to perform edge extraction processing on the first motion to obtain an edge graph corresponding to the first motion, determine at least one key point in the edge graph, obtain the binary mask corresponding to the target object in the to-be-processed image sample according to a position of the at least one key point, and obtain the sparse motion corresponding to the target object in the to-be-processed image sample according to a motion corresponding to the at least one key point.

In such a manner, according to the embodiments of the disclosure, unsupervised training may be performed on the first neural network through a large number of untagged image samples, and the first neural network obtained by training may predict a motion of the target object according to a guidance of a guidance point independently of a hypothesis about a strong association between the target object and the motion thereof, so that the quality of predicting the motion of the target object may be improved. Moreover, the first coding network in the first neural network may be used as an image coder to be used for a large number of advanced visual tasks (for example, target detection, semantic segmentation, instance segmentation and human parsing). A parameter of the image coder in the network corresponding to the advanced visual tasks may be initialized according to a parameter of the second coding network in the first neural network. The network corresponding to the advanced visual tasks may be endowed with relatively high performance during initialization, and the performance of the network corresponding to the advanced visual tasks may be greatly improved.

In some embodiments, functions or modules of the device provided in the embodiments of the disclosure may be configured to execute the method described in the above method embodiments and specific implementations thereof may refer to the descriptions about the method embodiments and, for simplicity, will not be elaborated herein.

Embodiments of the disclosure also disclose a computer-readable storage medium, in which computer program instructions are stored, the computer program instructions being executed by a processor to implement the method. The computer-readable storage medium may be a nonvolatile computer-readable storage medium.

Embodiments of the disclosure also disclose an electronic device, which includes a processor and a memory configured to store instructions executable for the processor, the processor being configured for the method.

Embodiments of the disclosure also disclose a computer program, which includes computer-readable codes, the computer-readable codes running in an electronic device to enable a processor of the electronic device to execute the abovementioned methods.

The electronic device may be provided as a terminal, a server or a device in another form.

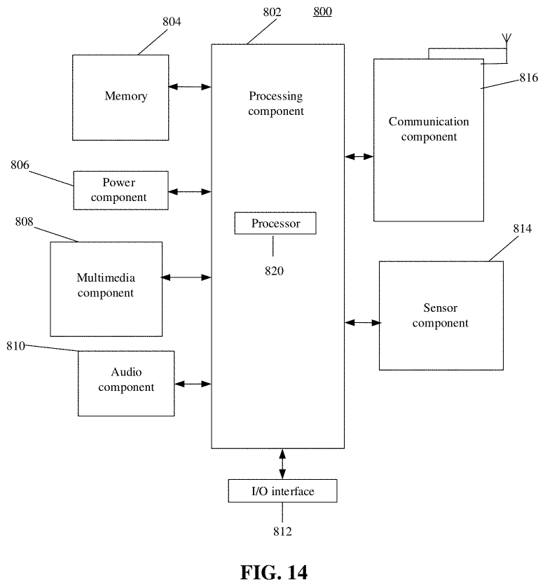

FIG. 14 is a block diagram of an electronic device 800 according to an exemplary embodiment. For example, the electronic device 800 may be a terminal such as a mobile phone, a computer, a digital broadcast terminal, a messaging device, a gaming console, a tablet, a medical device, exercise equipment and a PDA.

Referring to FIG. 14, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the steps in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device 800. Examples of such data include instructions for any application programs or methods operated on the electronic device 800, contact data, phonebook data, messages, pictures, video, etc. The memory 804 may be implemented by a volatile or nonvolatile storage device of any type or a combination thereof, for example, a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power component 806 provides power for various components of the electronic device 800. The power component 806 may include a power management system, one or more power supplies, and other components associated with generation, management and distribution of power for the electronic device 800.

The multimedia component 808 includes a screen providing an output interface between the electronic device 800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. The touch sensors may not only sense a boundary of a touch or swipe action but also detect a duration and pressure associated with the touch or swipe action. The front camera and/or the rear camera may receive external multimedia data when the electronic device 800 is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a Microphone (MIC), and the MIC is configured to receive an external audio signal when the electronic device 800 is in the operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 includes one or more sensors configured to provide status assessment in various aspects for the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 may access a communication-standard-based wireless network, such as a Wireless Fidelity (WiFi) network, a 2nd-Generation (2G) or 3rd-Generation (3G) network or a combination thereof. In an exemplary embodiment, the communication component 816 receives a broadcast signal or broadcast associated information from an external broadcast management system through a broadcast channel In an exemplary embodiment, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra-Wide Band (UWB) technology, a Bluetooth (BT) technology and another technology.

In the exemplary embodiments, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In the exemplary embodiments, a nonvolatile computer-readable storage medium is also provided, for example, a memory 804 including computer program instructions. The computer program instructions may be executed by a processor 820 of an electronic device 800 to implement the abovementioned method.

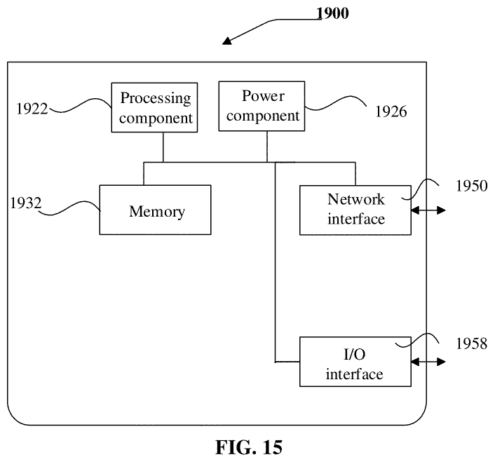

FIG. 15 is a block diagram of an electronic device 1900 according to an exemplary embodiment. For example, the electronic device 1900 may be provided as a server. Referring to FIG. 15, the electronic device 1900 includes a processing component 1922, further including one or more processors, and a memory resource represented by a memory 1932, configured to store instructions executable for the processing component 1922, for example, an application program. The application program stored in the memory 1932 may include one or more than one module of which each corresponds to a set of instructions. In addition, the processing component 1922 is configured to execute the instructions to execute the abovementioned method.

The electronic device 1900 may further include a power component 1926 configured to execute power management of the electronic device 1900, a wired or wireless network interface 1950 configured to connect the electronic device 1900 to a network and an I/O interface 1958. The electronic device 1900 may be operated based on an operating system stored in the memory 1932, for example, Windows Server™, Mac OS X™, Unix™, Linux™, FreeBSD™ or the like.

In the exemplary embodiments, a nonvolatile computer-readable storage medium is also provided, for example, a memory 1932 including computer program instructions. The computer program instructions may be executed by a processing component 1922 of an electronic device 1900 to implement the abovementioned method.

The disclosure may be a system, a method and/or a computer program product. The computer program product may include a computer-readable storage medium, in which computer-readable program instructions configured to enable a processor to implement each aspect of the disclosure is stored.

The computer-readable storage medium may be a physical device capable of retaining and storing instructions used by an instruction execution device. For example, the computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a RAM, a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instructions described here may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, optical fiber transmission, wireless transmission, a router, a firewall, a switch, a gateway computer and/or an edge server. A network adapter card or network interface in each computing/processing device receives the computer-readable program instructions from the network and forwards the computer-readable program instructions for storage in the computer-readable storage medium in each computing/processing device.

The computer program instructions configured to execute the operations of the disclosure may be assembly instructions, Instruction Set Architecture (ISA) instructions, machine instructions, machine related instructions, microcode(s), firmware instructions, state setting data or source codes or target codes edited by one or any combination of more programming languages, the programming language including an object-oriented programming language such as Smalltalk and C++ and a conventional procedural programming language such as “C” language or a similar programming language. The computer-readable program instructions may be completely executed in a computer of a user or partially executed in the computer of the user, executed as an independent software package, executed partially in the computer of the user and partially in a remote computer, or executed completely in the remote server or a server. Under the condition that the remote computer is involved, the remote computer may be connected to the computer of the user through any type of network including an LAN or a WAN, or, may be connected to an external computer (for example, connected by an Internet service provider through the Internet). In some embodiments, an electronic circuit such as a programmable logic circuit, an FPGA or a Programmable Logic Array (PLA) may be customized by use of state information of a computer-readable program instruction, and the electronic circuit may execute the computer-readable program instruction, thereby implementing each aspect of the disclosure.

Herein, each aspect of the disclosure is described with reference to flowcharts and/or block diagrams of the method, device (system) and computer program product according to the embodiments of the disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed substantially concurrently and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Each embodiment of the disclosure has been described above. The above descriptions are exemplary, non-exhaustive and also not limited to each disclosed embodiment. Many modifications and variations are apparent to those of ordinary skill in the art without departing from the scope and spirit of each described embodiment of the disclosure. The terms used herein are selected to explain the principle and practical application of each embodiment or improvements in the technologies in the market best or enable others of ordinary skill in the art to understand each embodiment disclosed herein.

1. An image processing method, comprising:
determining a guidance group set for a target object in a to-be-processed image, the guidance group comprising at least one guidance point, the guidance point being configured to indicate a position of a sampling pixel and a magnitude and direction of a motion velocity of the sampling pixel, and the sampling pixel being a pixel of the target object in the to-be-processed image; and
performing, according to the guidance point in the guidance group and the to-be-processed image, optical flow prediction to obtain a motion of the target object in the to-be-processed image.

2. The method of claim 1, wherein performing, according to the guidance point in the guidance group and the to-be-processed image, optical flow prediction to obtain the motion of the target object in the to-be-processed image comprises:
performing, according to the magnitude and direction of the motion velocity of the sampling pixel indicated by the guidance point in the guidance group, the position of the sampling pixel indicated by the guidance point in the guidance group and the to-be-processed image, optical flow prediction to obtain the motion of the target object in the to-be-processed image.

3. The method of claim 1, wherein performing, according to the guidance point in the guidance group and the to-be-processed image, optical flow prediction to obtain the motion of the target object in the to-be-processed image comprises:
generating, according to the magnitude and direction of the motion velocity of the sampling pixel indicated by the guidance point in the guidance group, a sparse motion corresponding to the target object in the to-be-processed image, the sparse motion being configured to indicate a magnitude and direction of a motion velocity of each sampling pixel of the target object;
generating, according to the position of the sampling pixel indicated by the guidance point in the guidance group, a binary mask corresponding to the target object in the to-be-processed image, the binary mask being configured to indicate a position of each sampling pixel of the target object; and
performing, according to the sparse motion, the binary mask and the to-be-processed image, optical flow prediction to obtain the motion of the target object in the to-be-processed image.

4. The method of claim 1, wherein performing, according to the guidance point in the guidance group and the to-be-processed image, optical flow prediction to obtain the motion of the target object in the to-be-processed image comprises:
performing optical flow prediction by inputting the guidance point in the guidance group and the to-be-processed image to a first neural network, to obtain the motion of the target object in the to-be-processed image.

5. The method of claim 3, wherein performing, according to the sparse motion, the binary mask and the to-be-processed image, optical flow prediction to obtain the motion of the target object in the to-be-processed image comprises:
performing feature extraction on the sparse motion corresponding to the target object in the to-be-processed image and the binary mask corresponding to the target object in the to-be-processed image to obtain a first feature;
performing feature extraction on the to-be-processed image to obtain a second feature;
performing connection processing on the first feature and the second feature to obtain a third feature; and
performing optical flow prediction on the third feature to obtain the motion of the target object in the to-be-processed image.

6. The method of claim 5, wherein performing optical flow prediction on the third feature to obtain the motion of the target object in the to-be-processed image comprises:
performing full-extent propagation processing by inputting the third feature to at least two propagation networks respectively, to obtain a propagation result corresponding to each of the at least two propagation network; and
performing fusion by inputting the propagation result corresponding to each propagation network to a fusion network, to obtain the motion of the target object in the to-be-processed image.

7. The method of claim 1, wherein determining the guidance group set for the target object in the to-be-processed image comprises:
determining multiple guidance groups set for the target object in the to-be-processed image, each of the multiple guidance groups comprising at least one guidance point different from guidance points of other guidance groups.

8. The method of claim 7, wherein performing, according to the guidance point in the guidance group and the to-be-processed image, optical flow prediction to obtain the motion of the target object in the to-be-processed image comprises:
performing, according to a guidance point in each guidance group and the to-be-processed image, optical flow prediction to obtain a motion, corresponding to a guidance of guidance group, of the target object in the to-be-processed image.

9. The method of claim 8, further comprising:
mapping the to-be-processed image according to the motion, corresponding to the guidance of each guidance group, of the target object to obtain a new image corresponding to each guidance group; and
generating a video according to the to-be-processed image and the new image corresponding to each guidance group.

10. The method of claim 1, wherein determining the guidance group set for the target object in the to-be-processed image comprises:
determining at least one first guidance point set for a first target object in the to-be-processed image; and
generating multiple guidance groups according to the at least one first guidance point, directions of first guidance points in a same guidance group being the same and directions of first guidance points in different guidance groups being different.

11. The method of claim 10, wherein performing, according to the guidance point in the guidance group and the to-be-processed image, optical flow prediction to obtain the motion of the target object in the to-be-processed image comprises:
performing, according to the first guidance point in each of the multiple guidance groups and the to-be-processed image, optical flow prediction to obtain a motion, corresponding to a guidance of each guidance group, of the first target object in the to-be-processed image.

12. The method of claim 11, further comprising:
fusing the motion, corresponding to the guidance of each guidance group, of the first target object in the to-be-processed image to obtain a mask corresponding to the first target object in the to-be-processed image.

13. The method of claim 11, further comprising:
determining at least one second guidance point set in the to-be-processed image, a motion velocity of the second guidance point being 0, wherein performing, according to the first guidance point in each guidance group and the to-be-processed image, optical flow prediction to obtain the motion, corresponding to the guidance of each guidance group, of the first target object in the to-be-processed image comprises:
performing, according to the first guidance point in each guidance group, the second guidance point and the to-be-processed image, optical flow prediction to obtain the motion, corresponding to the guidance of each guidance group, of the first target object in the to-be-processed image.

14. An electronic device, comprising:
a processor; and
a memory, configured to store instructions executable for the processor,
wherein when the instructions are executed by the processor, the processor is configured to:
determine a guidance group set for a target object in an to-be-processed image, the guidance group comprising at least one guidance point, the guidance point being configured to indicate a position of a sampling pixel and a magnitude and direction of a motion velocity of the sampling pixel and the sampling pixel being a pixel of the target object in the to-be-processed image; and
perform, according to the guidance point in the guidance group and the to-be-processed image, optical flow prediction to obtain a motion of the target object in the to-be-processed image.

15. The electronic device of claim 14, wherein the processor is further configured to:
perform, according to the magnitude and direction of the motion velocity of the sampling pixel indicated by the guidance point in the guidance group, the position of the sampling pixel indicated by the guidance point in the guidance group and the to-be-processed image, optical flow prediction to obtain the motion of the target object in the to-be-processed image.

16. The electronic device of claim 14, wherein the processor is further configured to:
generate, according to the magnitude and direction of the motion velocity of the sampling pixel indicated by the guidance point in the guidance group, a sparse motion corresponding to the target object in the to-be-processed image, the sparse motion being configured to indicate a magnitude and direction of a motion velocity of each sampling pixel of the target object;
generate, according to the position of the sampling pixel indicated by the guidance point in the guidance group, a binary mask corresponding to the target object in the to-be-processed image, the binary mask being configured to indicate a position of each sampling pixel of the target object; and
perform, according to the sparse motion, the binary mask and the to-be-processed image, optical flow prediction to obtain the motion of the target object in the to-be-processed image.

17. The electronic device of claim 14, wherein the processor is further configured to:
perform optical flow prediction by inputting the guidance point in the guidance group and the to-be-processed image to a first neural network, to obtain the motion of the target object in the to-be-processed image.

18. The electronic device of claim 16, wherein the processor is configured to:
perform feature extraction on the sparse motion corresponding to the target object in the to-be-processed image and the binary mask corresponding to the target object in the to-be-processed image to obtain a first feature;
perform feature extraction on the to-be-processed image to obtain a second feature;
perform connection processing on the first feature and the second feature to obtain a third feature; and
perform optical flow prediction on the third feature to obtain the motion of the target object in the to-be-processed image.

19. The electronic device of claim 18, wherein the processor is further configured to:
perform full-extent propagation processing by inputting the third feature to at least two propagation networks respectively, to obtain a propagation result corresponding to each propagation network; and
perform fusion performing by inputting the propagation result corresponding to each propagation network to a fusion network, to obtain the motion of the target object in the to-be-processed image.

20. A computer-readable storage medium, in which computer program instructions are stored, the computer program instructions being executed by a processor to perform:
determining a guidance group set for a target object in a to-be-processed image, the guidance group comprising at least one guidance point, the guidance point being configured to indicate a position of a sampling pixel and a magnitude and direction of a motion velocity of the sampling pixel, and the sampling pixel being a pixel of the target object in the to-be-processed image; and
performing, according to the guidance point in the guidance group and the to-be-processed image, optical flow prediction to obtain a motion of the target object in the to-be-processed image.
